(19) United States
(12) Patent Application Publication
(10) Pub. No.: US 2002/0094248 A1
(43) Pub. Date: Jul. 18, 2002

(54) Drilling attachment for a drill press

(76) Inventor: Darrin Smith, Penetanguishene (CA)

Correspondence Address: BIRCH STEWART KOLASCH & BIRCH, PO BOX 747, FALLS CHURCH, VA, 22040-0747, US

(21) Appl. No.: 10/041,501

(22) Filed: Jan. 10, 2002

(30) Foreign Application Priority Data
Jan. 12, 2001 (CA) 2,330,886

(51) Int. Cl. B23B 47/04

(52) U.S. Cl. 408/87; 408/124

(57) ABSTRACT

The drilling attachment has a drill mounted to revolve about a generally horizontal axis. A working surface on which a piece of stock is placed is mounted on a carriage which slides horizontally toward and away from the drill. The drill is mounted in a gear box which slides vertically on a pair of guide shafts.

### BACKGROUND OF THE INVENTION

This invention relates to a drilling attachment for a drill press and more particularly to an attachment for drilling a horizontal hole in a board or other object. The attachment is particularly suitable for drilling a hole in the side edge of a board or other thin object.

The drilling of a hole in a side edge presents a special challenge, particularly where the angle of the hole must be drilled to a close tolerance. Usually the hole is drilled by means of a drill press having a bit which rotates about a vertical axis and which may be raised and lowered by means of a quill feed. The board is clamped to a table beneath the bit such that the edge in which the hole is to be drilled is facing upward and the bit is lowered into the surface to make the hole.

The problem that is encountered when the hole is drilled in this manner is that the board may wobble while it is being drilled. It does so because the lower surface of the board which rests on the table is narrow like the upper surface. Unless the lower surface is perfectly flat the board may sway or vibrate from side to side as it is being drilled. The resulting hole will not be perfectly straight and its angle may not be within the required tolerance.

### SUMMARY OF THE INVENTION

I have found that if the hole is drilled horizontally as opposed to vertically, the area of the board which rests on the table is not the side edge but the large face of the board. The board can be much more effectively clamped and prevented from swaying or vibrating when it is in this position and the hole which is drilled in its side edge is much straighter and within a generally accepted tolerance.

The drilling attachment of the subject invention takes advantage of this finding. The attachment is suitable for use in conjunction with a conventional drill press in which the bit rotates about a vertical axis. Briefly the attachment includes: a drill mounted to revolve about a generally horizontal axis; a working surface on which a piece of work is adapted to be placed; and means for causing the working surface to move toward and away from the drill

### DESCRIPTION OF THE DRAWINGS

The drilling attachment of the invention is described with reference to the accompanying drawings in which:

FIG. 1 is a perspective view of the drilling attachment in conjunction with a drill press;

FIG. 2 is a side view of the drilling attachment and drill press;

FIG. 3 is a perspective view of the drilling attachment;

FIG. 4 is a plan view of the attachment;

FIG. 5 is a plan view of a carriage and drill showing the manner in which the position of a piece of work can be adjusted on the carriage; and

FIG. 6 is a view, partly in section and in enlarged scale, on line 6-6 of FIG. 5.

Like reference characters refer to like parts throughout the description of the drawings.

### DESCRIPTION OF THE PREFERRED EMBODIMENTS

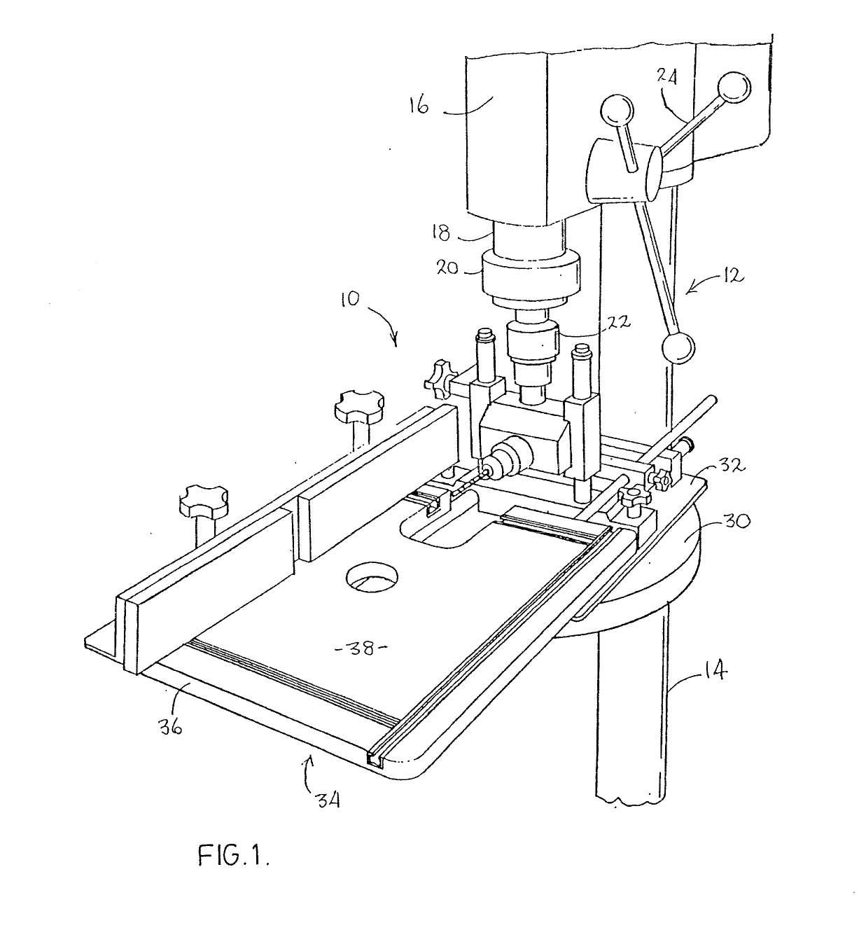

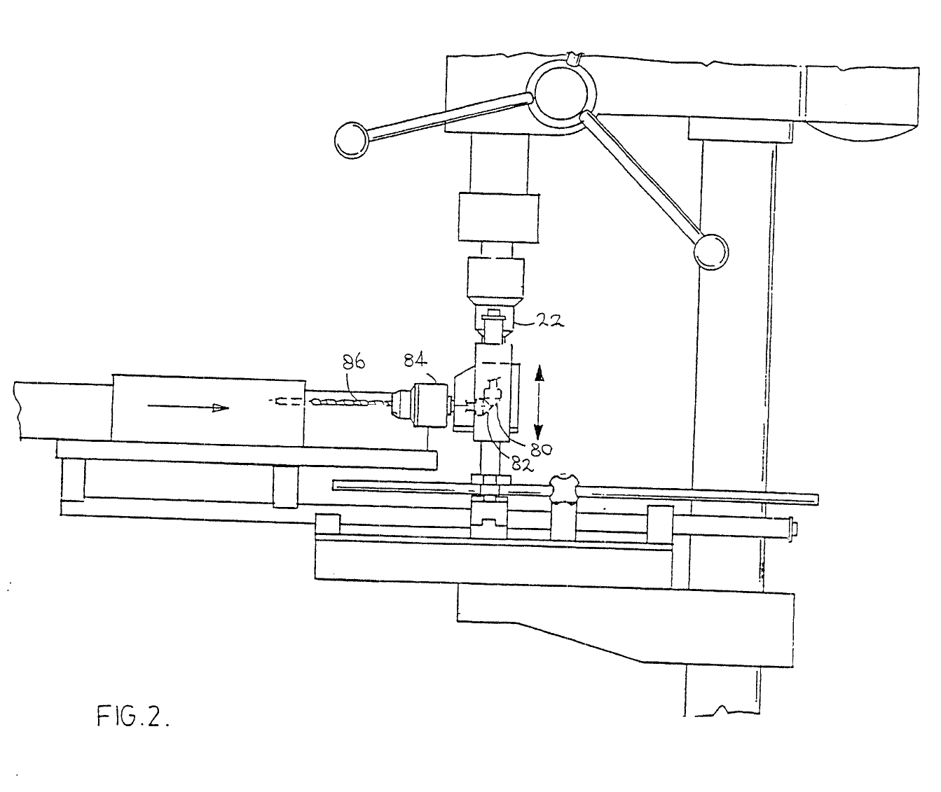

With reference to FIGS. 1 and 2, the drilling attachment of the invention, generally 10, is shown in conjunction with a conventional drill press, generally 12. The drill press has a pedestal (not illustrated) upon which a column 14 is mounted. A housing 16 for the motor which drives the drill is mounted at the top of the column.

A drive assembly activated by the motor extends downwardly from the housing. The assembly comprises a shaft 18, a quill 20 and a chuck 22. The components of the assembly are interconnected by conventional means such as by keys or splines. A handle or quill feed 24 serves to raise and lower the assembly. A table 30 is provided for supporting a platform on which a piece of work is seated.

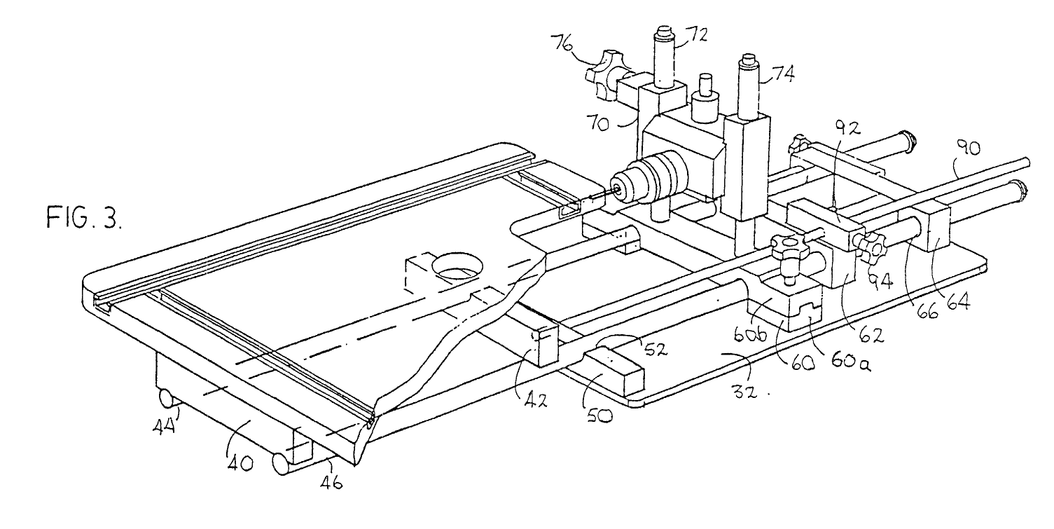

The drilling assembly of the invention has a base 32 which is bolted or otherwise secured to table 30. A carriage, generally 34, is seated on the base. The carriage has a panel 36 provided with a generally horizontal working surface 38 on which a piece of work is placed. Supports 40, 42 and guide rods 44,46 are attached to the lower wall of the panel as illustrated in FIG. 3.

As illustrated in that Figure, there are two supports, a forward support 40 and a rear support 42 and those supports rest upon and are connected to a pair of spaced guide rods 44, 46. It will be noted that the guide rods have axes which are generally parallel to the plane of the working surface of the panel. The rods are supported by a bar 50 at the outer end of base 32. The bar has a pair of spaced semi-circular depressions 52 in its upper surface in which the rods are received. The rods are not attached to the bar but are free to slide in the depressions.

Three further parallel bars extend upwardly from base 32, they being a gear box supporting bar 60, and intermediate and rear bars 62, 64. The bars each have a pair of circular openings 66 formed in them in which rods 44, 46 are free to slide.

A gear box 70 is supported by two vertically extending spaced guide shafts 72, 74. The shafts are seated in cylindrical openings in bar 60 and extend upwardly through cylindrical openings in the gear box. The gear box is accordingly free to slide vertically toward and away from bar 60.

A knob 76 is keyed or splined to a threaded pin which extends into the gear box and to shaft 72. Rotation of the knob in one direction causes the forward end of the pin to move into engagement with the shaft to prevent the gear box from sliding on the shafts. Rotation in the opposite direction allows the gear box to slide freely on the shafts. The pin thus selectively immobilizes the gear box and prevents it from sliding on the rods.

With reference to FIG. 2, bevel gears 80, 82 are mounted at right angles to each other within the gear box. Gear 80 has a spindle which extends upward and into chuck 22 where it is secured. The spindle of gear 82 is keyed to a chuck 84 in which a bit 86 is secured. The gear box accordingly converts rotation about a vertical axis to rotation about a horizontal axis.

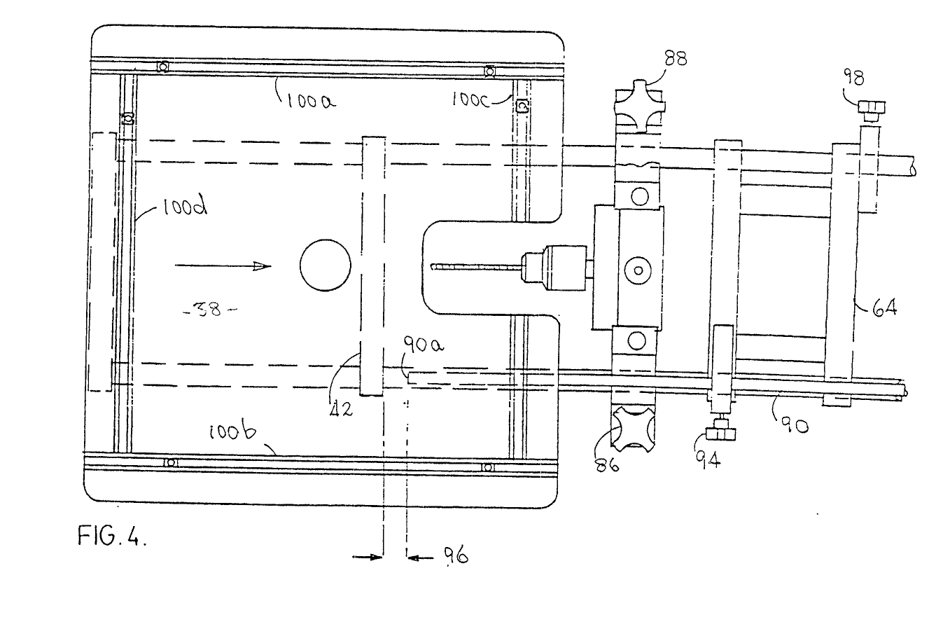

With reference to FIGS. 3 and 4, bar 60 is made up of lower and upper parts 60a, b. A pair of threaded pins (not illustrated) extend upward from base 32 and through cylindrical openings in the two parts of the bar. Knobs 86, 88 are rotatably connected to the upper ends of the pins. The knobs maybe removed from the pins by rotating them and when they are removed, the two parts may be separated from one another so that the gear box may be removed from the remainder of the drilling assembly.

A stop rod 90 is slidably received in a cylindrical opening in block 92 at the top of intermediate bar 62. The position of the stop rod may be adjusted by loosening knob 94 so that the rod may be moved forward and back as at 96 in FIG. 4.

The forward end 90a of the rod contacts rear support 42 and defines the point at which the carriage is closest to the drill press. Loosening of knob 94 allows the position of the stop rod to be altered. Movement of the rod to the right allows the carriage to come closer to the drill press and also lengthens the length of travel of the carriage. Movement of the rod to the left has the opposite result, i.e. the distance between the drill press and the carriage, at it closest point, lengthens, and the length of travel of the carriage shortens.

A knob 98 is located at the end of rear bar 64. Connected to the knob is a threaded stem (not illustrated) that moves into and out of engagement with guide rod 44 depending on which way the knob is rotated. The knob and stem thus act as an immobilizing means for selectively preventing the working surface from moving relative to the drill. The knob and stem do so by preventing the guide rods from moving relative to base 32.

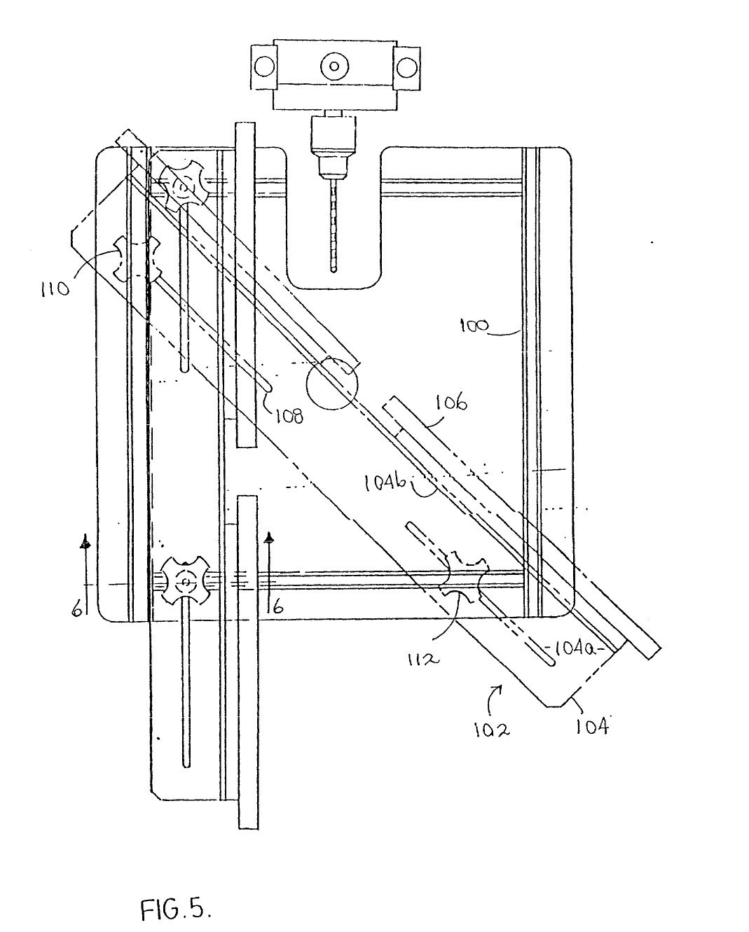

With reference to FIGS. 4 and 5, a number of grooves 100 is formed in the upper working surface of the panel of the carriage. One set of grooves 100a, b extend parallel to the direction of travel of the carriage while a second set 100c, d extend normally to the direction of travel. By means of the grooves, the position of fence, generally 102, can be adjusted.

The fence comprises an L-shaped angle plate 104 having a lower horizontal wall 104a which rests on the working surface and a vertical wall 104b to which a backing board 106 is attached. Longitudinally extending slots 108 are formed in the lower wall for receipt of fasteners 110, 112.

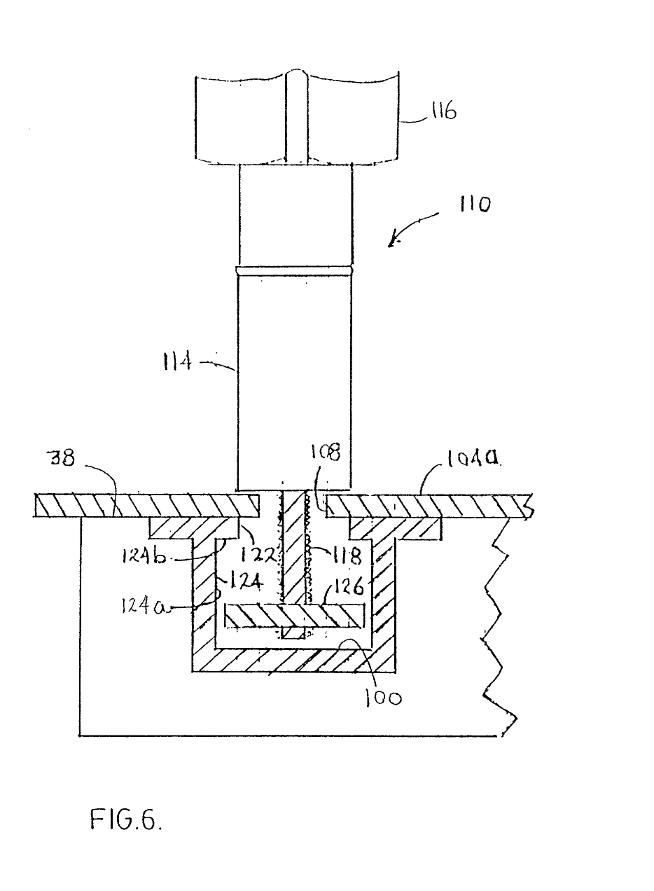

With reference to FIG. 6, fastener 110 has a shank 114 to which a knob 116 is connected. A threaded stem 118 extends downwardly from the shank, through slot 108 in the panel and into a groove 100.

The groove is somewhat in the shape of an upside down “T” having a vertical extent 122 which extends downwardly from working surface 38 and terminates at a horizontal extent 124. A square nut 126 is slidingly received in the groove. The stem is threadably received in the central threaded bore of the nut.

Rotation of knob 116 in one direction causes the threaded stem to rotate in the bore of the nut. The nut is in contact with the side wall 124a of the groove and cannot rotate with the stem. The nut rises as the knob is rotated in that direction and eventually moves into contact with the upper wall 124b of the groove. The fastener then becomes immovable in the groove.

Rotation of the knob in the opposite direction causes the nut to descend and the fastener will then become free to move in the groove.

The combination of the threaded stem, slot and nut acts as an immobilizing means for selectively preventing the fence from moving relative to the working surface. Knob 116 acts to engage and disengage the immobilizing means.

As illustrated in FIG. 5, the fasteners may be in parallel grooves 100c,d or they may be in grooves 100a,c that intersect each other. The angle which the bit is to drill in the piece of work will determine the angle of the fence against which the work piece abuts and hence the grooves in which the fasteners must be located.

The operation of the drilling attachment of the invention is as follows. A piece of work is placed against backing board 106. The position of the fence is then adjusted by loosening the fasteners and sliding them in grooves 100 until the piece of work is in the correct position. The quill feed is then rotated in order to cause the drive assembly and gear box 70 to descend. When the bit is in the correct position vis a vis the piece of work, carriage 34 is pushed forward to cause the bit to drill the hole in the work piece.

It will be understood of course that modifications can be made in the structure of the drilling attachment described herein without departing from the scope and purview of the invention as defined in the appended claims.

I claim:

1. A drilling attachment for a drill press comprising: a drill mounted to revolve about a generally horizontal axis; a working surface on which a piece of work is adapted to be placed; and means for causing said working surface to move toward and away from said drill.

2. The drilling attachment as claimed in claim 1 wherein said working surface is generally horizontal.

3. The drilling attachment as claimed in claim 1 further including: a fence which is movable relative to said working surface and which is adapted to steady said work piece; and immobilizing means for selectively preventing said fence from moving relative to said working surface.

4. The drilling attachment as claimed in claim 2 further including: a fence which is movable relative to said working surface and which is adapted to steady said work piece, said fence having a planar face which extends upwardly from said working surface and against which said work piece is adapted to abut, said fence being movable in order to selectively alter the orientation of said face; and immobilizing means for selectively preventing said fence from moving relative to said working surface.

5. The drilling attachment as claimed in claim 4 wherein said fence is movable such that the orientation of said face may be changed from a position in which said face is normal to the axis of said drill to a position in which said face is parallel to said axis.

6. The drilling attachment as claimed in claim 3 wherein said working surface has at least one groove formed therein, said immobilizing means including: a fastener which extends into said groove; and securing means within said groove for selectively immobilizing said fastener in said groove.

7. The drilling attachment as claimed in claim 6 wherein said securing means is a nut which is free to move vertically in said groove but which is non-rotatable therein, said fastener including: a threaded stem which is threadably connected to said nut and which extends outwardly from said groove; and a handle attached to said stem for selectively imparting rotation thereto, rotation of said handle in one direction causing said nut to move vertically into frictional contact with a wall which defines said groove with resulting immobilization of said fastener in said groove.

8. The drilling attachment as claimed in claim 1 further including second immobilizing means for selectively preventing said working surface from moving relative to said drill.

9. The drilling attachment as claimed in claim 3 wherein said working surface has two pairs of grooves formed therein, one said pair being oriented at an angle parallel to the axis of said drill, and the other said pair being oriented at an angle normal to said axis, said immobilizing means including: a fastener which extends into said groove; and securing means within said groove for selectively immobilizing said fastener in said groove.

10. The drilling attachment as claimed in claim 9 wherein said securing means is a nut which is free to move vertically in said groove but which is non-rotatable therein, said fastener including: a threaded stem which is threadably connected to said nut and which extends outwardly from said groove; and a handle attached to said stem for selectively imparting rotation to said stem, rotation of said handle in one direction causing said nut to move vertically into frictional contact with a wall which defines said groove with resulting immobilization of said fastener in said groove.

11. A drilling attachment as claimed in claim 1 further including a carriage which is adapted to be slidably mounted to said drill press and to which said working surface is attached, said carriage being slidable toward and away from said drill press.

12. The drilling attachment as claimed in claim 11 further including an adjustable stop means for limiting the movement of said carriage.

13. The drilling attachment as claimed in claim 11 wherein said carriage has a pair of rods which is adapted to extend outwardly from said drill press and on which said carriage slides.

14. The drilling attachment as claimed in claim 13 wherein said stop means is a rod

15. The drilling attachment as claimed in claim 1 further including means for vertical adjustment of said drill above said working surface.

16. The drilling attachment as claimed in claim 15 further including a base adapted to be immobilized relative to said drill press; a guide shaft which extends vertically upward from said base; and a gear box mounted to slide vertically on said guide shaft, said drill extending outwardly from said gear box.

17. The drilling attachment as claimed in claim 15 further including a base adapted to be immobilized relative to said drill press; a pair of spaced vertically extending guide shafts which extends vertically upward from said base; and a gear box mounted to slide vertically on said guide shafts, said drill extending outwardly from said gear box.

18. The drilling attachment as claimed in claim 16 further including means for selectively preventing said gear box from sliding on said guide shaft.

19. The drilling attachment as claimed in claim 17 further including means for selectively preventing said gear box from sliding on said guide shafts.
